(19) United States
(12) Patent Application Publication
(10) Pub. No.: US 2004/0200302 A1
(43) Pub. Date: Oct. 14, 2004

(54) Toothed-gear drive unit with automatic compensation for tooth-flank backlash

(76) Inventors: Gunter Kampichler, Ruhstorf (DE); Ernst Gschweitl, Gleisdorf (AT)

Correspondence Address: KATTEN MUCHIN ZAVIS ROSENMAN, 575 MADISON AVENUE, NEW YORK, NY, 10022-2585, US

(21) Appl. No.: 10/833,848

(22) Filed: Apr. 28, 2004

Related U.S. Application Data
(63) Continuation of application No. PCT/EP03/06151, filed on Jun. 12, 2003.

(30) Foreign Application Priority Data
Jun. 15, 2002 (DE) 102 26 850.9

(51) Int. Cl. F16H 55/18

(52) U.S. Cl. 74/409; 74/440

(57) ABSTRACT

A device for compensating for the tooth backlash between two toothed gears in engagement with one another, with a toothed disk, which is connected in parallel with one of the toothed gears and provided with the same gear pitch, and which is held such that it can be hydraulically adjusted relative thereto until it bears against the non-force-transmitting tooth flanks of the mating toothed gear. In order to achieve a design that is as simple as possible and requires little mounting space, there must be provided at least one hydraulic adjusting element, which exerts an adjusting force in circumferential direction on the toothed gear and which is equipped with a steel piston held adjustably in a housing and urged by a spring as well as by pressurized fluid supplied via a check valve.

### CROSS-REFERENCE TO RELATED APPLICATIONS

This is a continuation of International Application PCT/EP03/06151, filed Jun. 12, 2003.

### FIELD OF THE INVENTION

The present invention relates to a toothed-gear drive unit with a toothed gear comprising two toothed-gear disks, which are braced against one another relative to their axis of rotation, and at least one meshing mating gear, with automatic compensation for any tooth-flank backlash that occurs during meshing engagement.

### BACKGROUND OF THE INVENTION

A toothed-gear drive unit should be designed such that the tooth-flank backlash is neither too small nor too large, since otherwise the toothed gears can seize up or clattering noises can develop. This occurs in particular in toothed-gear drive units loaded by fluctuating torques, such as crankshaft drive units of internal combustion engines, in which high-frequency vibrations perceptible as running noise are generated if the tooth-flank backlash is too large.

This problem is magnified by the additional thermal expansion of the materials, which are frequently unlike, used to manufacture toothed-gear drive units. For example, audible noises due to thermally generated tooth-flank backlash can already develop as an internal combustion engine is warming up. Aside from the unpleasant running noises, toothed-gear drives with large tooth-flank backlash are subject to increased wear, which can substantially impair the service life of an internal combustion engine.

Toothed-gear drives in which the tooth-flank backlash can be reduced or compensated for are known. For example, there is used for this purpose a toothed gear comprising two toothed-gear disks, which are subjected to initial tension between one another by means of a spring disposed between the two toothed-gear disks. If such a toothed gear meshes with another toothed gear, the teeth of the toothed-gear disks mutually fit into the tooth spaces of the other toothed gear and, by virtue of the initial spring tension, compensate for any tooth-flank backlash that may occur. If oppositely directed torques occur, they are transmitted without tooth-flank backlash by means of the spring-braced toothed-gear parts.

A disadvantage of such toothed-gear drive units, however, is that the spring constants of the springs bracing the toothed-gear disks must be large, especially for the case of occurrence of large reaction torques. A large spring constant, however, means high friction loss of the toothed-gear drive unit, and so the service life of such a toothed-gear drive unit can be expected to be shortened by wear. In any case, the fluctuating torques that can be transmitted without tooth-flank backlash are limited in magnitude. If large reaction torques occur, for example in the form of running irregularities or jolts, compensation for tooth-flank backlash is generally no longer assured.

In another known solution, the teeth of the toothed gears meshing with one another are decoupled by an interposed rubber layer. However, such a toothed-gear drive unit substantially conceals the same disadvantages as the toothed-gear drive unit already depicted in the foregoing, namely increased friction loss with only limited transmittable fluctuating torques, and ultimately service-life problems due to increased wear.

It would therefore be desirable to have a toothed-gear drive unit in which the tooth-flank backlash is compensated for even if very high reaction torques occur, without having to tolerate increased wear due to increased friction loss of the toothed-gear drive unit.

German Offenlegungsschrift (Unexamined Application) 3901076 A1 describes a device for compensating for the tooth backlash of two toothed gears meshing with one another, wherein one of the toothed gears is connected in parallel with a toothed disk and is held such that it can be hydraulically adjusted by means of a hydraulic adjusting element until it bears against the non-force-transmitting tooth flanks of the mating toothed gear. A check valve is used to absorb reaction torque. In this device for compensating for tooth backlash, the hydraulic adjusting element is fixed externally on the toothed gear cooperating with the toothed disk.

U.S. Pat. No. 4,739,670 describes a mechanism for compensating for tooth backlash wherein a toothed gear that meshes with another toothed gear is composed of two toothed-gear disks which, for the purpose of compensating for tooth backlash, are braced against one another by three springs disposed in circumferential direction.

### SUMMARY OF THE INVENTION

According to the invention, there is shown a toothed-gear drive unit for automatic compensation for any tooth-flank backlash that occurs during meshing engagement, with a toothed gear comprising two toothed-gear disks braced against one another relative to their axis of rotation, and with at least one meshing mating gear, wherein the toothed-gear disks are mutually braced by at least one hydraulic piston-cylinder unit, which is equipped with a check valve and whose piston cooperates with a first toothed-gear disk in such a way that, upon actuation of the said piston, the other, second toothed-gear disk comes to bear with the tooth flank that is trailing relative to the direction of rotation against the mating gear, and which is characterized in that the at least one hydraulic piston-cylinder unit is constructed such that it is integral with the first toothed-gear disk. In this way return movement of the piston under the effect of the torques acting counter to the direction of rotation is prevented by the check valve.

When the toothed gear comprising two toothed-gear disks meshes with the mating gear, at least one tooth of each of the toothed-gear disks engages in a tooth space of the mating gear. Turning of the two toothed-gear disks relative to one another as a result of the bracing action therefore takes place only until the teeth of the two toothed-gear disks bear with force against the flanks of the tooth spaces. The bracing action of the two toothed-gear disks is produced by the piston force of the piston of the piston-cylinder unit, which is actuated via a hydraulic pressurized medium. If a reaction torque occurs, any associated return movement of the piston is prevented by the check valve and the reaction torque is transmitted without flank backlash by means of the braced toothed-gear disks.

In this situation it is particularly advantageous that the magnitude of a reaction torque to be transmitted without flank backlash by the inventive toothed-gear drive unit is limited only by the check valve. In addition, it is sufficient that the tooth flanks of the toothed-gear disks press on the flanks of the tooth spaces of the mating gear with sufficient force to generate oppositely directed flank contact. Thus, in contrast to the prior art, it is not necessary that the respective flanks press with sufficient force to transfer large reaction torques without flank backlash. Furthermore, the piston force can be regulated via the hydraulic pressurized medium.

In the present invention, automatic compensation for any tooth-flank backlash that exists always takes place in particularly advantageous manner by the bracing action of the two toothed-gear disks. This is the case in particular when the tooth-flank backlash varies with time, for example due to thermal expansion or wear caused by rubbing.

According to the invention, it is advantageous if, in a toothed-gear disk (“main gear”), the width of the teeth defined in axial direction of the toothed gear is larger than that of the other toothed-gear disk (“compensating gear”). The main gear in this case functions as the driving or driven toothed-gear disk. The compensating gear functions to compensate for the tooth-flank backlash and for transmission of reaction torques without tooth-flank backlash.

### BRIEF DESCRIPTION OF THE DRAWINGS

The invention will now be explained in more detail on the basis of several practical examples, with reference to the attached drawings, wherein:

FIG. 1 shows a schematic radial section through a toothed gear with two braced toothed-gear disks on a shaft according to the present invention;

FIG. 2 shows a schematic axial section through a toothed gear on a shaft according to FIG. 1;

FIG. 3 shows schematic radial and axial sections through an inventive toothed-gear drive unit, wherein the ratio of the axial widths of the teeth of the braced toothed-gear disks is approximately 3:1; and

FIG. 4 shows schematic radial and axial sections through an inventive toothed-gear drive unit with a toothed gear comprising two braced toothed-gear disks as the middle gear, wherein the ratio of the axial widths of the teeth of the toothed-gear disks is approximately 1:1.

### DETAILED DESCRIPTION OF THE INVENTION

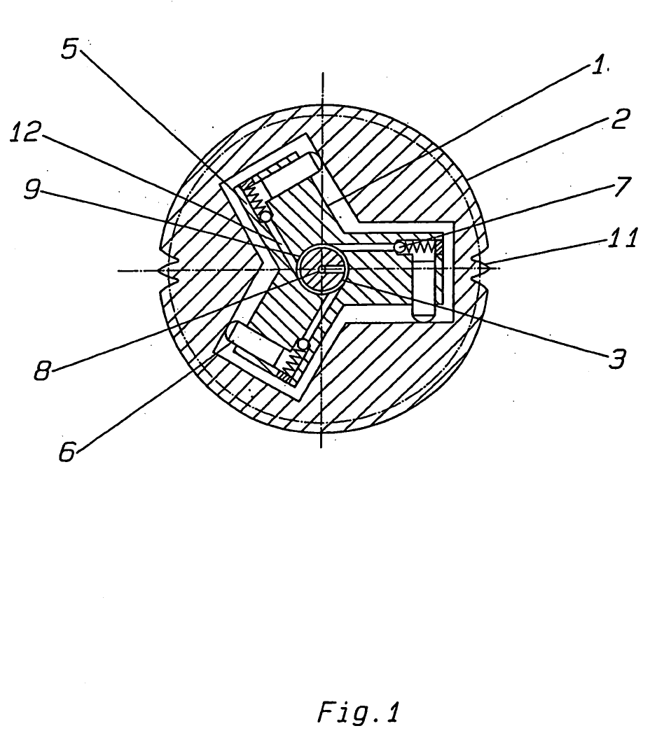

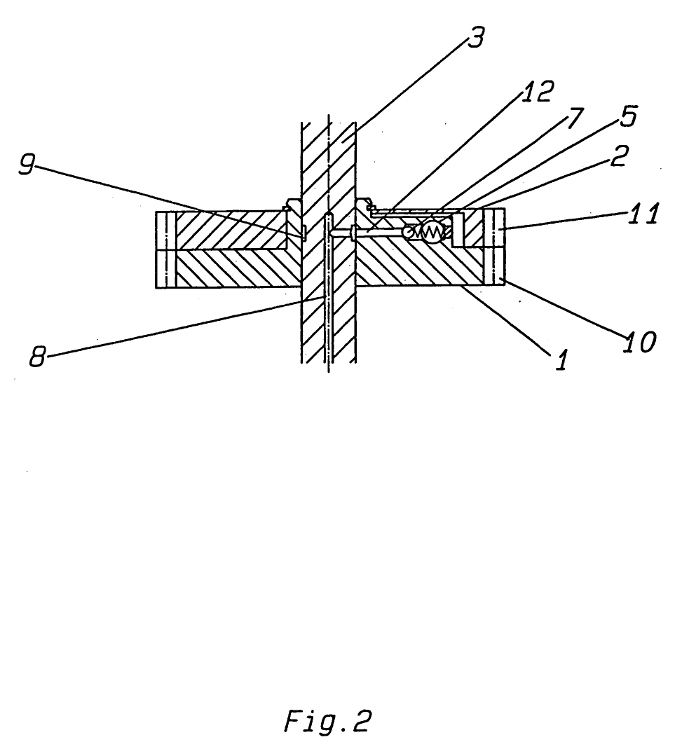

FIG. 1 and FIG. 2 will be considered first. FIG. 1 shows a radial section through a toothed gear with two braced toothed-gear disks on a shaft; FIG. 2 shows an axial section thereof. The toothed gear is composed of two toothed-gear disks 1, 2. Only one toothed-gear disk 1 (“main gear”) is mounted on shaft 3 to rotate therewith, while the other toothed-gear disk 2 (“compensating gear”) is disposed in a recess of toothed-gear disk 1 mounted on shaft 3. Toothed-gear disk 1 and toothed-gear disk 2 can be turned relative to one another.

Main gear 1 is equipped on its outer circumference with a toothing 10, while compensating gear 2 is provided on its outer circumference with a toothing 11. Toothings 10, 11 of toothed-gear disks 1, 2 together form the toothing of the toothed gear.

In the respective recesses of main gear 1 mounted on shaft 3 to rotate therewith there are disposed, in circumferential direction, at approximately equal angular spacings, three piston-cylinder units 5. Each piston 6 of a piston-cylinder unit 5 acts on main gear 1 in such a way that, upon actuation thereof, compensating gear 2 bears with the tooth flank that is trailing relative to the direction of rotation against the mating gear.

Actuation of piston 6 takes place by means of a hydraulic pressurized medium. The force exerted during flank contact in opposite directions depends on the piston force of hydraulic piston-cylinder units 5. This can be regulated via the hydraulic pressurized medium for actuation of piston 6.

Within a toothed-gear drive unit, main drive or takeoff drive torques are transmitted directly to the mating gear via main gear 1 mounted on shaft 3 to rotate therewith and its toothing 10. By virtue of the bracing action of main gear 1 and compensating gear 2 inside the tooth spaces of the mating gear, reaction torques are also transmitted without tooth-flank backlash. Blocking of the braced toothed-gear disks 1, 2 under the effect of reaction torques that occur is achieved by check valves 7. Return movement of piston 6 is prevented regardless of the magnitude of the reaction torques. The magnitude of the reaction torques that can be transmitted without flank backlash is limited only by the blowout resistance of check valves 7.

To supply piston-cylinder units 5 with a hydraulic pressurized medium, shaft 3 is provided with an axial supply channel 8, which opens into an annular groove 9 at the height of toothed-gear part 1. Annular groove 9 is in fluid-conducting communication with supply channels 12, which are provided inside toothed-gear part 1 and through which the hydraulic pressurized medium is ultimately supplied to piston-cylinder units 5.

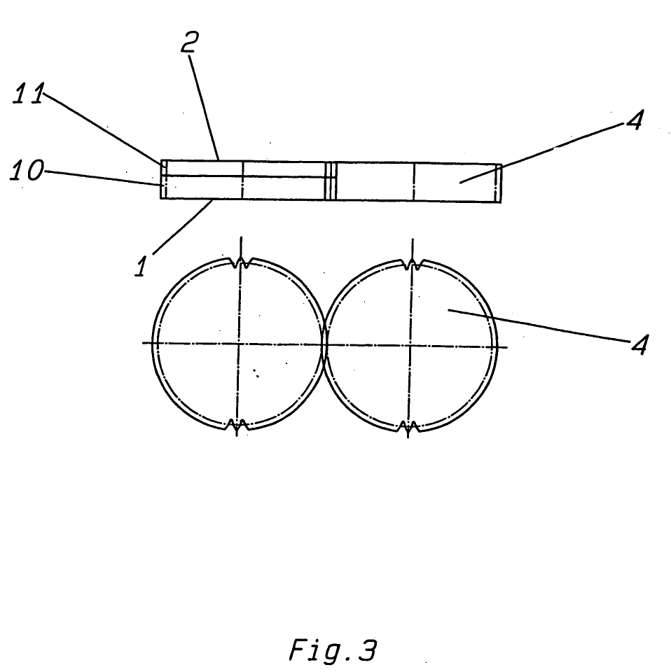

FIG. 3 will now be considered. Therein there is schematically illustrated a toothed-gear drive unit with a toothed gear comprising main gear 1 and compensating gear 2 (at the left in the drawing) as well as a mating gear 4. The lower diagram shows a radial section and the upper diagram shows an axial section. In the illustrated embodiment, the widths of toothing 10 of main gear 1 and of toothing 11 of compensating gear 2 defined in axial direction of the toothed gear are chosen such that the ratio thereof is approximately 3:1. The main torques occurring during normal use of the toothed-gear drive unit are in this case transmitted to mating gear 4 via main gear 1, which is mounted on a shaft to rotate therewith and which has the broader toothing 10. If reaction torques occur, they are transmitted without backlash via the compensating gear, which has toothing 11 of smaller width.

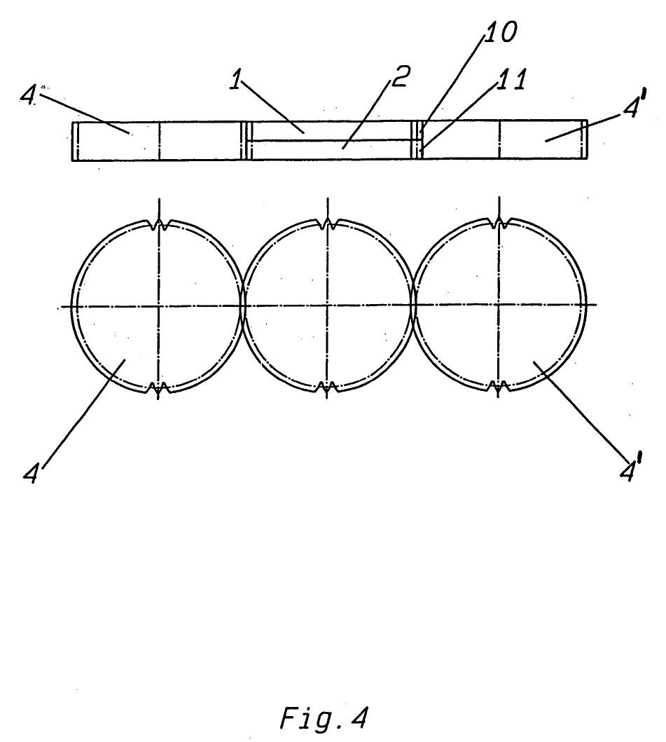

Finally, FIG. 4 shows the use of a toothed gear with two braced toothed-gear disks as the middle gear, which meshes with two mating gears 4, 4′. The widths of toothing 10 of main gear 1 and toothing 11 of compensating gear 2 are approximately equal. Because of the almost equal width of toothings 10, 11, the toothed-gear drive unit shown in FIG. 4 is suitable for transmission of fluctuating torques that vary in direction of rotation.

Although the invention has been illustrated by the example of a radial-toothed toothed-gear drive unit, it is not limited thereto. To the contrary, the invention relates to toothed-gear drive units having radial, helical, herringbone or bevel toothing, as well as to rack-and-pinion drive units and quite generally to toothed-gear drive units in which at least one of the toothed elements is mounted on a shaft to rotate therewith.

In the inventive toothed-gear drive unit, the toothed gear comprising two braced toothed-gear disks can be used as the driving gear or the takeoff gear. As the driving gear it is seated, for example, on the crankshaft of an internal combustion engine. Furthermore, the use as an idler gear revolving without load is also intended.

An inventive toothed-gear drive unit can be used, for example, for driving the oil pump or valves of an internal combustion engine.

We claim:

1. A toothed-gear drive unit with automatic compensation for tooth-flank backlash that occurs during meshing engagement with a toothed gear comprising:
first and second toothed-gear disks braced against one another relative to their axis of rotation, and at least one meshing mating gear, and
at least one hydraulic piston-cylinder unit having a piston and check valve for mutually bracing the two toothed-gear disks, said piston cooperating with the first toothed-gear disk in such a way that, upon actuation of said piston, the second toothed-gear disk comes to bear with its tooth flank that is trailing relative to the direction of rotation against the meshing mating gear with return movement of the piston under the effect of the torques acting counter to the direction of rotation being prevented by the check valve,
wherein the at least one hydraulic piston-cylinder unit is constructed such that it is integral with the first toothed-gear disk.
